(19) United States
(12) Patent Application Publication
(10) Pub. No.: US 2017/0018282 A1
(43) Pub. Date: Jan. 19, 2017

(54) AUDIO PROCESSING SYSTEM AND AUDIO PROCESSING METHOD THEREOF

(71) Applicant: Chunghwa Picture Tubes, LTD., Taoyuan City (TW)

(72) Inventors: Shih-Lung Tsai, Penghu County (TW); Chien-Hung Chen, New Taipei City (TW)

(21) Appl. No.: 14/801,669

(22) Filed: Jul. 16, 2015

(51) Int. Cl. G10L 25/78; G10L 15/08

(52) U.S. Cl. CPC G10L 25/78; G10L 15/08

(57) ABSTRACT

An audio processing system and an audio processing method thereof are provided. A first audio signal and at least one second audio signal from different directions are received by audio receivers. A first component signal and a second component signal are calculated by separating the first audio signal. A third component signal and a fourth component signal are calculated by separating the second audio signal. A major voice information is obtained by calculating the first component signal and the third component signal. A non-major voice information is obtained by calculating the second component signal and the fourth component signal. The non-major voice information is subtracted from the first audio signal to obtain a calculation result. The calculation result and the major voice information are added to obtain a major voice signal in the first audio signal and the at least one second audio signal.

### BACKGROUND OF THE INVENTION

1. Field of the Invention

The present invention generally relates to an audio processing technology, in particular, to an audio processing system and an audio processing method thereof adapted to an interactive display system in the Internet of Things (IoT).

2. Description of Related Art

With the continuous development of science and technology advances, interactive technology has been developed as a new input/output (I/O) interface to provide a good operating experience. For an interactive display device, a voice recognition may be used to identify a voice signal from a user by comparing a voice feature of the voice signal with a database. Besides, a voice instruction corresponding to the voice signal may be also identified, such that the interactive display device may execute a corresponding operation based on the voice instruction.

The voice recognition may be correct in case of the received voice signal from the user without ambient noises. However, background noises, such as noises in an environment and/or noises produced by devices in the interactive display system, may be usually accompanied with the voice signal received by the audio receiver, resulting in the quality of the voice recognition may be degraded.

### SUMMARY OF THE INVENTION

Accordingly, the present invention is directed to an audio processing system and an audio processing method thereof, which may effectively extract a major voice signal, and therefore may enhance accuracy of the voice recognition.

The invention provides an audio processing method, which is adapted to an audio processing system includes an audio receiving device including a plurality of audio receivers. The audio processing method includes following steps. A first audio signal and at least one second audio signal from different directions are received by the audio receivers. A first component signal and a second component signal are calculated by separating the first audio signal. A third component signal and a fourth component signal are calculated by separating each of the at least one second audio signal. A major voice information is obtained by calculating the first component signal and the at least one third component signal. A non-major voice information is obtained by calculating the second component signal and the at least one fourth component signal. The non-major voice information is subtracted from the first audio signal to obtain a calculation result. The calculation result and the major voice information are added to obtain a major voice signal in the first audio signal and the at least one second audio signal.

In an embodiment of the invention, the audio receivers include a first audio receiver and at least one second audio receiver. The step of receiving the first audio signal and the at least one second audio signal from different directions by the audio receivers includes receiving the first audio signal by the first audio receiver and receiving the at least one second audio signal by the at least one second audio receiver. Herein, the major voice signal is generated by a sound source, and the first audio receiver is used for receiving a maximum intensity of the major voice signal generated by the sound source, and the at least one second audio receiver is used for detecting noises of the major voice signal.

In an embodiment of the invention, the audio processing system further includes a display unit, configured to a first side of the audio processing system, and used for displaying a message corresponding to the major voice signal, wherein the first audio receiver is configured to the first side of the audio processing system, and the at least one second audio receiver is configured to at least one second side of the audio processing system, wherein the at least one second side and the first side are different.

In an embodiment of the invention, the audio processing system further includes a wearable electronic device, and the first audio receiver is configured in the wearable electronic device. The step of receiving the first audio signal by the first audio receiver includes connecting with the wearable electronic device through a wireless communication connection and receiving the first audio signal received by the first audio receiver through the wireless communication connection.

In an embodiment of the invention, the audio processing system further comprises a first wireless communication unit. The step of connecting with the wearable electronic device through the wireless communication connection includes pairing with a second wireless communication unit of the wearable electronic device to establish the wireless communication connection with the second wireless communication unit by the first wireless communication unit.

In an embodiment of the invention, the first wireless communication unit comprises at least one of a WiFi module or a Bluetooth module.

In an embodiment of the invention, the step of obtaining the major voice information by calculating the first component signal and the at least one third component signal includes subtracting the at least one third component signal from the first component signal to generate the major voice information.

In an embodiment of the invention, the step of obtaining the non-major voice information by calculating the second component signal and the at least one fourth component signal includes subtracting the at least one fourth component signal from the second component signal to generate the non-major voice information.

In an embodiment of the invention, the method further includes comparing the major voice signal with a database for a voice recognition and executing a corresponding operation according to the major voice signal.

In an embodiment of the invention, the step of comparing the major voice signal with the database for the voice recognition includes determining whether a voice feature of the major voice signal is identical to one of a plurality of voice features stored in the database, and when the voice feature of the major voice signal is not identical to the voice features stored in the database, storing the voice feature of the major voice signal into the database.

The invention provides an audio processing system including an audio receiving device and a processing unit. The audio receiving device includes a plurality of audio receivers, and is used for receiving a first audio signal and at least one second audio signal from different directions. The processing unit is coupled to the audio receiving device, and used for calculating a first component signal and a second component signal by separating the first audio signal, calculating a third component signal and a fourth component signal by separating each of the at least one second audio signal, obtaining a major voice information by calculating the first component signal and the at least one third component signal, obtaining a non-major voice information by calculating the second component signal and the at least one fourth component signal, subtracting the non-major voice information from the first audio signal to obtain a calculation result, and adding the calculation result and the major voice information to obtain a major voice signal in the first audio signal and the at least one second audio signal.

In an embodiment of the invention, the audio receivers include a first audio receiver and at least one second audio receiver. The first audio receiver receives the first audio signal, and the at least one second audio receiver receives the at least one second audio signal. The major voice signal is generated by a sound source, and the first audio receiver is used for receiving a maximum intensity of the major voice signal generated by the sound source, and the at least one second audio receiver is used for detecting noises of the major voice signal.

In an embodiment of the invention, the audio processing system further includes a display unit. The display unit is configured to a first side of the audio processing system, and is used for displaying a message corresponding to the major voice signal. The first audio receiver is configured to the first side of the audio processing system, and the at least one second audio receiver is configured to at least one second side of the audio processing system, wherein the at least one second side and the first side are different.

In an embodiment of the invention, the audio processing system further includes a wearable electronic device. The wearable electronic device is coupled to the processing unit. The first audio receiver is configured in the wearable electronic device. The processing unit connects with the wearable electronic device through a wireless communication connection, and receives the first audio signal received by the first audio receiver through the wireless communication connection.

In an embodiment of the invention, the audio processing system further includes a first wireless communication unit. The first wireless communication unit is coupled to the processing unit, and is used for pairing with a second wireless communication unit of the wearable electronic device to establish the wireless communication connection with the second wireless communication unit.

In an embodiment of the invention, the first wireless communication unit comprises at least one of a WiFi module or a Bluetooth module.

In an embodiment of the invention, the processing unit is used to subtract the at least one third component signal from the first component signal to generate the major voice information.

In an embodiment of the invention, the processing unit is used to subtract the at least one fourth component signal from the second component signal to generate the non-major voice information.

In an embodiment of the invention, the processing unit is used to compare the major voice signal with a database for a voice recognition, and is used to execute a corresponding operation according to the major voice signal.

In an embodiment of the invention, the processing unit is used to determine whether a voice feature of the major voice signal is identical to one of a plurality of voice features stored in the database, and when the voice feature of the major voice signal is not identical to the voice features stored in the database, the processing unit stores the voice feature of the major voice signal into the database.

Based on the above, the audio processing system and the audio processing method thereof disclosed by the embodiments of the invention may receive audio signals from different directions and separate each of the audio signals into a major voice component signal and a non-major voice component signal regarded as noises. Thereby, noises may be effectively reduced based on the non-major voice component signals, and the intensity of the major voice signal may be increased based on the major voice component signals, so as to enhance voice quality and accuracy of voice recognition.

### BRIEF DESCRIPTION OF THE DRAWINGS

FIG. 1 is a block diagram illustrating an audio processing system according to an embodiment of the invention.

FIG. 2 is a flow chart illustrating an audio processing method according to an embodiment of the invention.

FIG. 3 is a schematic diagram illustrating an interactive display system according to an embodiment of the invention.

FIG. 4A and FIG. 4B are schematic diagrams illustrating an audio processing method according to an embodiment of the invention.

FIG. 5 is a flow chart illustrating an audio processing method according to an embodiment of the invention.

FIG. 6 is a schematic diagram illustrating another interactive display system according to another embodiment of the invention.

FIG. 7 is a flow chart illustrating an audio processing method according to another embodiment of the invention.

### DESCRIPTION OF THE EMBODIMENTS

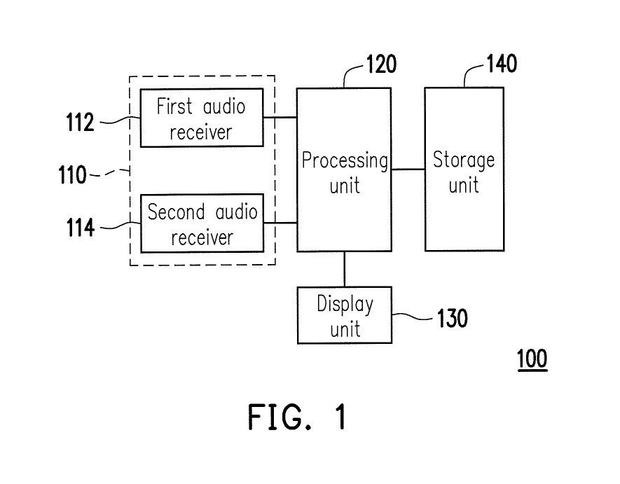

FIG. 1 is a block diagram illustrating an audio processing system according to an embodiment of the invention. Referring to FIG. 1, the audio processing system 100 includes an audio receiving device 110, a processing unit 120, a display unit 130 and a storage unit 140, where the functionalities thereof are given as follows.

The audio receiving device 110, for example, may include a plurality of audio receivers, which may be used for receiving a plurality of audio signals from different directions. In the present embodiment, the audio receivers may include a first audio receiver 112 and at least one second audio receiver. As shown in FIG. 1, merely a second audio receiver 114 is illustrated for convenience. However, the invention is not intended to limit the number of the second audio receiver. It should be noted that the first audio receiver 112 may be used for receiving a maximum intensity of the major voice signal generated by a sound source, and the at least one second audio receiver (e.g. the second audio receiver 114) may be used for detecting noises of the major voice signal.

The processing unit 120 may be, for example, a single chip, a general-purpose processor, a special-purpose processor, a traditional processor, a digital signal processor (DSP), a plurality of microprocessors, or one or more microprocessors, controllers, microcontrollers, application specific integrated circuit (ASIC), or field programmable gate arrays (FPGA) with a DSP core. In the present embodiment, the processing unit 120 is configured to implement the proposed audio processing method.

The display unit 130 may be, for example, a liquid crystal display (LCD), a light-emitting diode (LED) display, a field emission display (FED) or other types of display. In some embodiments, the display screen 110 can also be a touch display screen formed by one of the aforementioned displays and a resistive touch panel, a capacitive touch panel, an optical touch panel, or an ultrasonic touch panel, etc., so as to simultaneously provide a display function and a touch operation function.

The storage unit 140 is configured to store data (e.g. the received audio signals, signals generated by executing signal separating process, major voice information and non-major voice information, etc.) and accessible by the processing unit 120. In the present embodiment, the storage unit 140 may include a database for storing voice features, which is used for executing the voice recognition. The storage unit 140 may be, for example, a hard disk drive (HDD), a volatile memory, or a non-volatile memory.

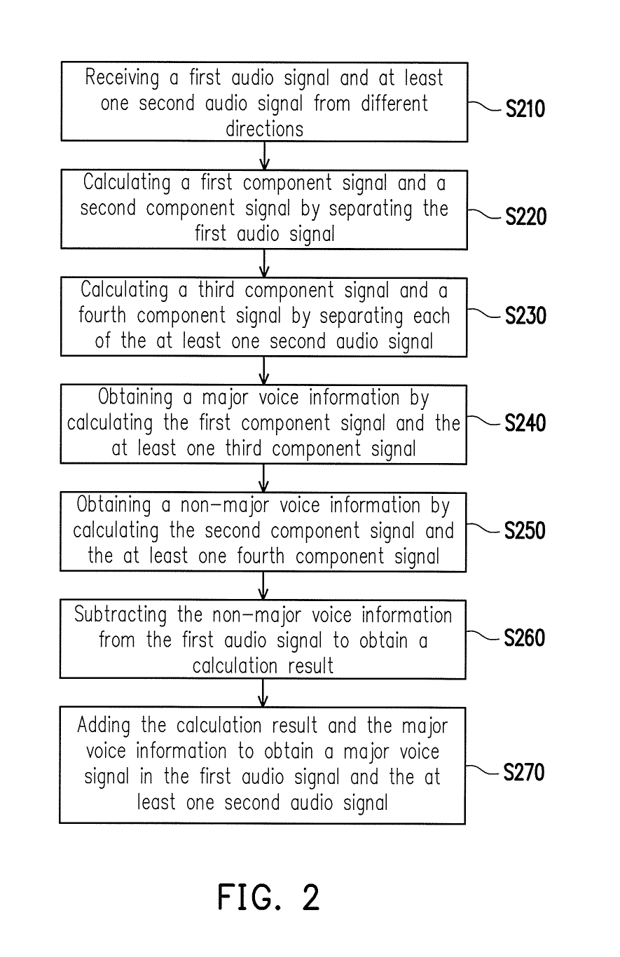

FIG. 2 is a flow chart illustrating an audio processing method according to an embodiment of the invention, which is adapted to the audio processing system 100 in FIG. 1. Detailed steps of the proposed method will be illustrated along with the components of the audio processing system 100 hereafter.

Referring to FIG. 1 and FIG. 2, in Step S210, a first audio and at least one second audio signal are received from different directions by the audio receivers. Specifically, in the present embodiment, the first audio receiver 112 may be used for receiving the first audio signal, and the at least one second audio receiver 114 may be used for receiving the at least one second audio signal.

In Step S220, the processing unit 120 calculates a first component signal and a second component signal by separating the first audio signal. In Step S230, the processing unit 120 calculates a third component signal and a fourth component signal by separating each of the at least one second audio signal.

In detail, the processing unit 120 may execute an independent component analysis (ICA) to execute signal separating process to separate the first audio signal and the at least one second audio signal. In addition, the first component signal may be a major voice component signal in the first audio signal, and the second component signal may be a non-major voice component signal, such as environment noises or other, with respect to the first component signal. Similarly, the at least one third component signal may be a major voice component signal in the second audio signal, and the at least one fourth component signal may be a non-major voice component signal with respect to the third component signal.

In Step S240, the processing unit 120 obtains a major voice information by calculating the first component signal and the third component signal. In Step S250, the processing unit 120 obtains a non-major voice information by calculating the second component signal and the fourth component signal.

Specifically, the major voice information may be calculated based on a weight ratio between the first component signal and the third component signal, and similarly, the non-major voice information may be calculated based on a weight ratio between the second component signal and the fourth component signal. In particular, the calculation based on the weight ratio between the first component signal and the third component signal and the weight ratio between the between the second component signal and the fourth component signal may be implemented by signal subtraction process. For instance, in an embodiment, the processing unit 120 may be used to subtract the at least one third component signal from the first component signal to generate the major voice information. In addition, the processing unit 120 may be used to subtract the at least one fourth component signal from the second component signal to generate the non-major voice information.

In Step S260, the processing unit 120 subtracts the non-major voice information from the first audio signal to obtain a calculation result, and then in Step S270, the processing unit 120 adds the calculation result and the major voice information to obtain a major voice signal in the first audio signal and the at least one second audio signal.

Hence, by using multiple audio receivers and executing the signal separation process to each of the received audio signals, the present embodiment may obtain the non-major voice information and the major voice information. Then, the non-major voice information may be used for eliminating noises of the major voice signal, and further the major voice information may be used for enhancing the intensity of the major voice signal. Thereby, voice quality may be effectively improved.

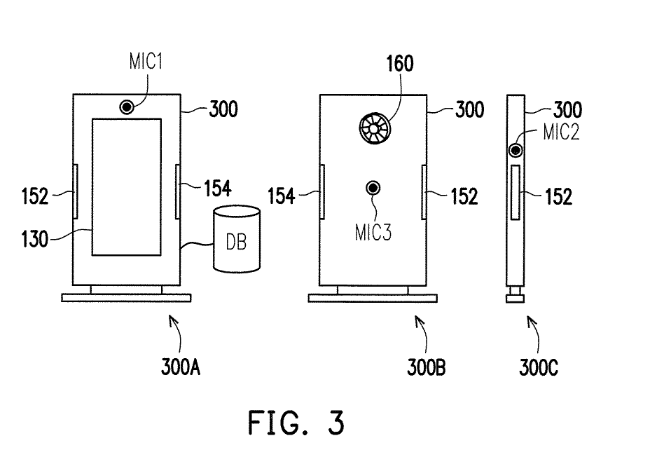

FIG. 3 is a schematic diagram illustrating an interactive display system according to an embodiment of the invention, where a front view 300A, a back view 300B and a side view 300C of an interactive display system 300 are illustrated respectively. The audio processing system of the interactive display system 300 may be implemented based on the audio processing system 100 in FIG. 1. Therefore, the audio processing system of the interactive display system 300 may also include the audio receiving device 110, the processing unit 120, the display unit 130 and the storage unit 140 with similar functionalities as described in the aforementioned embodiments. For convenience of the following description, merely the display unit 130 included in the audio processing system of the interactive display system 300 is illustrated in FIG. 3.

In the present embodiment, the display unit 130 may be configured to a front side (i.e. a first side) of the interactive display system 300 (shown in the front view 300A). The audio receiving device 110 includes audio receivers MIC1, MIC2 and MIC3 for receiving a plurality of audio signals from different directions. It should be noted that, in order to effectively receiving a voice instruction and a voice feature of the user (i.e. the major voice signal) and noises respectively, the audio receiver MIC1 may be configured to the front side (shown in the front view 300A), and the audio receivers MIC2 and MIC3 may be configured to other sides (i.e. the at least one second side), which may be different from the front side. In the embodiment of FIG. 3, the audio receiver MIC2 may be configured to a side face (shown in the side view 300C), and the audio receiver MIC3 may be configured to a rear of the interactive display system 300 (shown in the back view 300B). Therefore, the audio receiver MIC2 may be used for receiving noises produced by a speaker 152, and the second audio receiver MIC3 may be used for receiving noises produced by speakers 152, 154 and a fan 160. In other words, the audio receivers MIC2 and MIC3 (i.e. the at least one second audio receiver) may be used for detecting the noises of the major voice signal. Besides, the audio receiver MIC1 (i.e. the first audio receiver) may be used for receiving a maximum intensity of the major voice signal generated by the sound source (i.e. the user).

It is worth mentioning that, in the audio processing system of the interactive display system 300, the storage unit 140 may include a database DB, which is used for storing a plurality of voice features for voice recognition. Details will be described later.

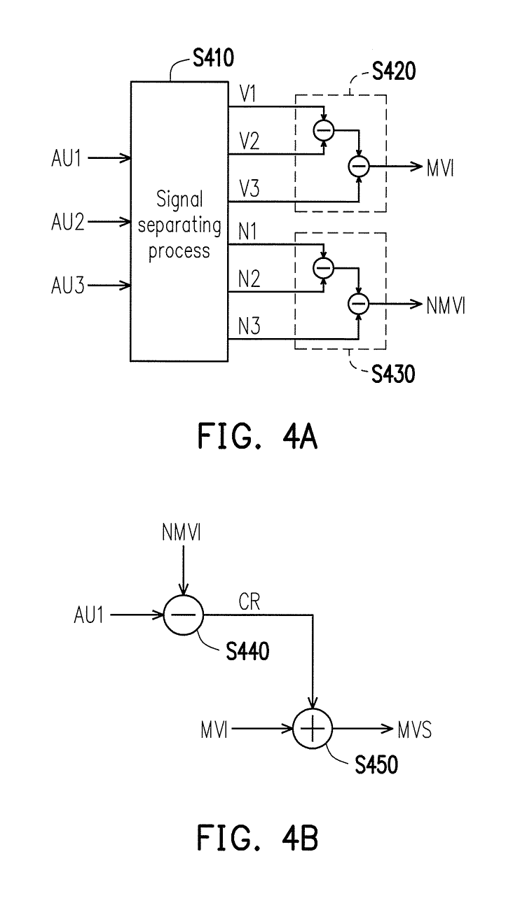

Based on the aforementioned configuration, the following embodiments in FIG. 4A and FIG. 4B illustrate the audio processing in detail.

FIG. 4A and FIG. 4B are schematic diagrams illustrating an audio processing method according to an embodiment of the invention, which is adapted to the audio processing system of the interactive display system 300 in FIG. 3.

Referring to FIG. 4A at first, the audio receiver MIC1 MIC2 and MIC3 may receive audio signals AU1, AU2 and AU3 respectively, where the audio signal AU1 may correspond to the first audio signal, and the audio signals AU2, AU3 may correspond to the second audio signal. Then, in step S410, the processing unit 120 may execute the signal separating process to each of the audio signals AU1, AU2 and AU3. In the present embodiment, the audio signal AU1 may be separated into a voice component signal V1 and a noise component signal N1, the audio signal AU2 may be separated into a voice component signal V2 and a noise component signal N2, and the audio signal AU3 may be separated into a voice component signal V3 and a noise component signal N3.

In Step S420, the processing unit 120 may obtain a major voice information MVI by subtracting the voice component signal V2 and voice component signal V3 from the voice component signal V1. On the other hand, in Step S430, the processing unit 120 may obtain a non-major voice information NMVI by subtracting the noise component signal N2 and noise component signal N3 from the noise component signal N1. The execution order of the Step S420 and 430 may be adjusted based on design requirements.

Next, referring to FIG. 4B, the processing unit 120 may use the audio signal AU1, the non-major voice information NMVI and the major voice information MVI to extract the major voice signal MVS. Specifically, in Step S440, the processing unit 120 may subtract the non-major voice information NMVI from the audio signal AU1 to obtain a calculation result CR. Then, in Step S450, the processing unit 120 may adding the calculation result CR and the major voice information MVI to obtain the major voice signal MVS in the audio signals AU1, AU2 and AU3.

It is worth mentioning that, the processing unit 120 may execute the operations in Step S420, S430, S440 and S450 in a time domain. In other embodiments, the processing unit 120 may convert the audio signals AU1, AU2 and AU3 from the time domain into a frequency domain, and then execute the operations in Step S420, S430, S440 and S450. In other words, the invention is not intended to limit the signal form used in the aforementioned calculation.

The following embodiment describes an audio processing process based on the audio processing system of the interactive display system 300 in FIG. 3.

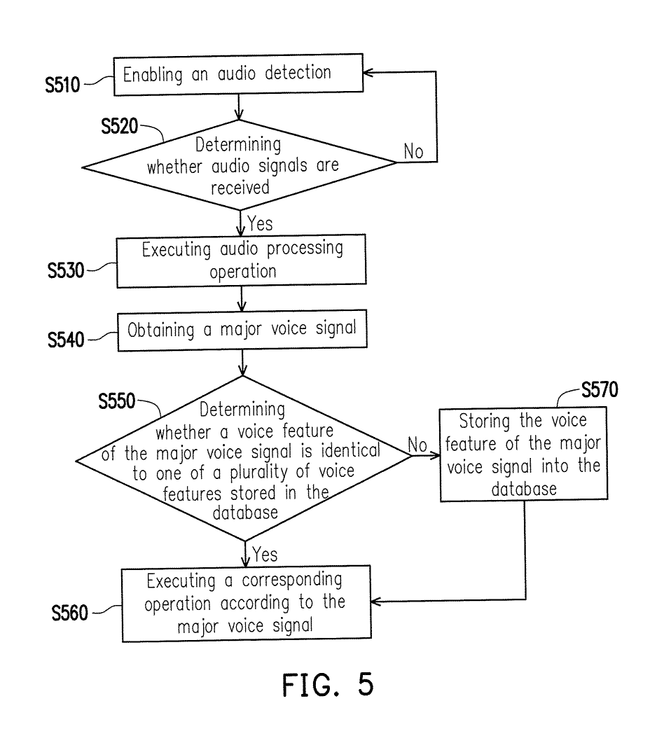

FIG. 5 is a flow chart illustrating an audio processing method according to an embodiment of the invention. Referring to FIG. 5, in Step 510, the processing unit 120 enables an audio detection. For instance, the processing unit 120 may enable the audio detection triggered by cases such as receiving an enabling operation from the user or detecting a face of the user in front of the display unit 130.

In Step S520, the processing unit 120 determines whether the audio signals AU1, AU2 and AU3 are received by the audio receivers MIC1, MIC2 and MIC3. When the audio signals AU1, AU2 and AU3 are received, in Step S530, the processing unit 120 executes the audio processing operation which is illustrated in detail in the embodiments of FIG. 4A and FIG. 4B, and thus obtains the major voice signal MVS in Step S540.

After the major voice signal MVS is extracted from the received audio signals AU1, AU2 and AU3, the processing unit 120 may be used to compare the major voice signal MVS with the database DB for a voice recognition. In brief, in Step S550, the processing unit 120 is used to determine whether a voice feature of the major voice signal MVS is identical to one of a plurality of voice features stored in the database DB. When the voice feature of the major voice signal MVS is identical to a stored voice feature in the database DB, in Step S560, the processing unit 120 is used to execute a corresponding operation according to the major voice signal MVS. For instance, the processing unit 120 may display a corresponding massage on the display unit 130 according to the major voice signal MVS, or may output a response message by the speakers 152 and 154 in response to the major voice signal MVS.

On the other hand, when the voice feature of the major voice signal MVS is not identical to the voice features stored in the database, in Step S570, the processing unit stores the voice feature of the major voice signal MVS into the database DB, and then enters the Step S560 to execute the corresponding operation according to the major voice signal MVS.

Thereby, by receiving audio signals from different directions and executing the signal separation process to each of the received audio signals, the embodiments of the invention may effectively extract the clear major voice signal MVS, so as to apply for the voice recognition with good accuracy and for a voice training process by updating the stored voice features in the database DB.

It should be noted that configurations of the first audio receiver 112 may be adaptively adjusted based on design requirements. In another embodiment, the audio processing system may be applied for an interactive display system including a wearable electronic device and an interactive display device, where the first audio receiver 112 may be configured in the wearable electronic device. The embodiment will be described in detail hereafter.

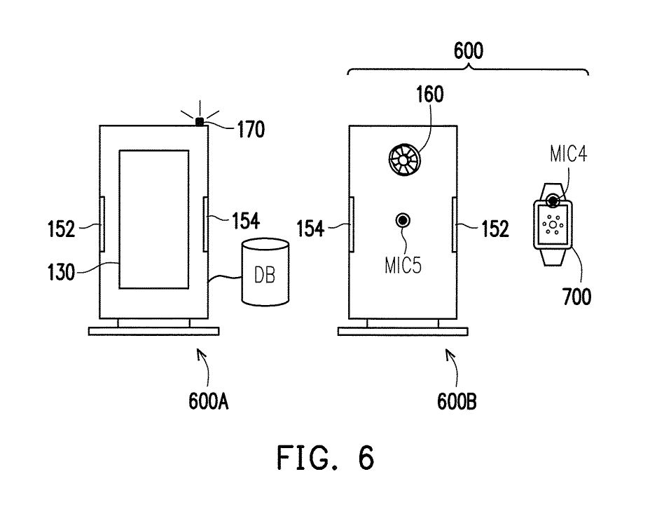

FIG. 6 is a schematic diagram illustrating another interactive display system according to another embodiment of the invention, where a front view 600A and a back view 600B of an interactive display device in an interactive display system 600 are illustrated respectively. The audio processing system of the interactive display system 600 may be implemented based on the audio processing system 100 in FIG. 1. Therefore, the audio processing system of the interactive display system 600 may also include the audio receiving device 110, the processing unit 120, the display unit 130 and the storage unit 140 with similar functionalities as described in the aforementioned embodiments. Similarly, for convenience of the following description, merely the display unit 130 included in the audio processing system of the interactive display system 600 is illustrated in FIG. 6.

In the present embodiment, the audio processing system of the interactive display system 600 further includes a wireless communication unit 170 and a wearable electronic device 700, where the processing unit 120 may connect with the wearable electronic device 700 by the wireless communication unit 170.

Besides, the audio receiving device 110 includes audio receivers MIC4 and MIC5 for receiving a plurality of audio signals from different directions. It should be noted that, for ease to use, the audio receivers MIC4 may be configured in the wearable electronic device 700. Thus, the audio receiver MIC4 (i.e. the first audio receiver) may be used for receiving a maximum intensity of the major voice signal generated by the sound source (i.e. the user). As for the audio receiver MIC5 (i.e. the at least one second audio receiver), it may be configured to a rear of the interactive display device (shown in the back view 600B) for receiving noises produced by speakers 152, 154 and a fan 160.

It should be noted that, in the present embodiment, the processing unit 120 may connect with the wearable electronic device 700 through a wireless communication connection, and may receive the first audio signal through the wireless communication connection by the audio receiver MIC4. More specifically, the processing unit 120 may pair with a second wireless communication unit (not shown) of the wearable electronic device 700 to establish the wireless communication connection with the second wireless communication unit by the first wireless communication unit 170. The first wireless communication unit 170 may include at least one of a WiFi module or a Bluetooth module.

Based on the aforementioned configuration, the audio processing system of the interactive display system 600 may extract the major voice signal by executing an audio processing method similar to the embodiments disclosed in FIG. 4A and FIG. 4B, so details may be omitted here. It is worth mentioning that one difference between the present embodiment and the aforementioned embodiments is that the present embodiment may omit a second audio receiver configured to the side face of the audio processing system (e.g. the audio receiver MIC2 as shown in FIG. 3). Thus, the audio processing method may be simplified in the present embodiment with respect to the aforementioned embodiments.

The following embodiment describes an audio processing process based on the audio processing system 100 of the interactive display system 600 in FIG. 6.

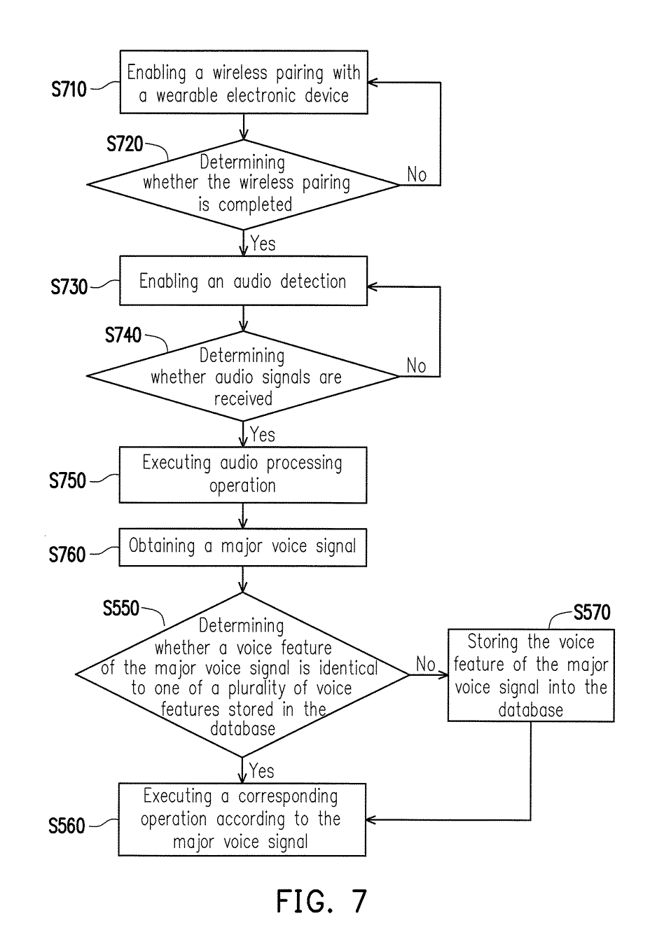

FIG. 7 is a flow chart illustrating an audio processing method according to another embodiment of the invention. Referring to FIG. 7, in Step 710, the processing unit 120 enables a wireless pairing with a wearable electronic device 700. In Step S720, the processing unit 120 determines whether the wireless pairing is completed. As mentioned above, the wireless pairing may be used for establishing the wireless connection between the first wireless communication unit 170 and the second wireless communication unit of the wearable electronic device 700.

When the wireless pairing is completed (i.e. the wireless communication unit is established), in Step S730, the processing unit 120 enables an audio detection. Then, in Step S740, the processing unit 120 determines whether audio signals are received by the audio receivers MIC4 and MIC5. When the audio signals are received, in Step S750, the processing unit 120 executes the audio processing operation, and then obtains a major voice signal in Step S760. The Step S730, S740, S750 and S760 may be similar to the Step S510, S520, S530 and S540 in FIG. 5, and thus details may not be described here. After the Step S760, the processing unit 120 in the present embodiment may execute the voice recognition by the process of the Step S550, S560 and S570 as the aforementioned embodiments, so details may be referred to the aforementioned.

To conclude the above, the embodiments disclosed by the invention may use a plurality of audio receivers to receive audio signals from different directions, and execute the signal separating process for separating each of the received audio signals into a major voice component signal and a non-major voice component signal. Therefore, noises may be effectively reduced from the received audio signal based on the non-major voice component signals, and the intensity of the major voice signal may also be increased based on the major voice component signals. Besides, the embodiments disclosed by the invention may be adapted to multiple system architectures, so as to be easy for operation by the user. Accordingly, the major voice signal may be clearly extracted, such that the voice quality may be improved and accuracy of the voice recognition may be enhanced.

What is claimed is:

1. An audio processing method, adapted to an audio processing system comprising an audio receiving device, wherein the audio receiving device comprises a plurality of audio receivers, the audio processing method comprising the following steps:
receiving a first audio signal and at least one second audio signal from different directions by the audio receivers;
calculating a first component signal and a second component signal by separating the first audio signal;
calculating a third component signal and a fourth component signal by separating each of the at least one second audio signal;
obtaining a major voice information by calculating the first component signal and the at least one third component signal;
obtaining a non-major voice information by calculating the second component signal and the at least one fourth component signal;
subtracting the non-major voice information from the first audio signal to obtain a calculation result; and
adding the calculation result and the major voice information to obtain a major voice signal in the first audio signal and the at least one second audio signal.

2. The method of claim 1, wherein the audio receivers comprising a first audio receiver and at least one second audio receiver, and the step of receiving the first audio signal and the at least one second audio signal from different directions by the audio receivers comprising:
receiving the first audio signal by the first audio receiver; and
receiving the at least one second audio signal by the at least one second audio receiver,
wherein the major voice signal is generated by a sound source, and the first audio receiver is used for receiving a maximum intensity of the major voice signal generated by the sound source, and the at least one second audio receiver is used for detecting noises of the major voice signal.

3. The method of claim 2, wherein the audio processing system further comprises a display unit, configured to a first side of the audio processing system, and used for displaying a message corresponding to the major voice signal, wherein the first audio receiver is configured to the first side of the audio processing system, and the at least one second audio receiver is configured to at least one second side of the audio processing system, wherein the at least one second side and the first side are different.

4. The method of claim 2, wherein the audio processing system further comprises a wearable electronic device, the first audio receiver is configured in the wearable electronic device, and the step of receiving the first audio signal by the first audio receiver comprising:
connecting with the wearable electronic device through a wireless communication connection; and
receiving the first audio signal received by the first audio receiver through the wireless communication connection.

5. The method of claim 4, wherein the audio processing system further comprises a first wireless communication unit, and the step of connecting with the wearable electronic device through the wireless communication connection comprising:
pairing with a second wireless communication unit of the wearable electronic device to establish the wireless communication connection with the second wireless communication unit by the first wireless communication unit.

6. The method of claim 5, wherein the first wireless communication unit comprises at least one of a WiFi module or a Bluetooth module.

7. The method of claim 1, wherein the step of obtaining the major voice information by calculating the first component signal and the at least one third component signal comprising:
subtracting the at least one third component signal from the first component signal to generate the major voice information.

8. The method of claim 1, wherein the step of obtaining the non-major voice information by calculating the second component signal and the at least one fourth component signal comprising:
subtracting the at least one fourth component signal from the second component signal to generate the non-major voice information.

9. The method of claim 1, further comprising:
comparing the major voice signal with a database for a voice recognition; and
executing a corresponding operation according to the major voice signal.

10. The method of claim 9, wherein the step of comparing the major voice signal with the database for the voice recognition comprising:
determining whether a voice feature of the major voice signal is identical to one of a plurality of voice features stored in the database; and
when the voice feature of the major voice signal is not identical to the voice features stored in the database, storing the voice feature of the major voice signal into the database.

11. An audio processing system, comprising:
an audio receiving device, comprising a plurality of audio receivers, used for receiving a first audio signal and at least one second audio signal from different directions; and
a processing unit, coupled to the audio receiving device, calculating a first component signal and a second component signal by separating the first audio signal, calculating a third component signal and a fourth component signal by separating each of the at least one second audio signal, obtaining a major voice information by calculating the first component signal and the at least one third component signal, obtaining a non-major voice information by calculating the second component signal and the at least one fourth component signal, subtracting the non-major voice information from the first audio signal to obtain a calculation result, and adding the calculation result and the major voice information to obtain a major voice signal in the first audio signal and the at least one second audio signal.

12. The audio processing system according to claim 11, wherein the audio receivers comprising a first audio receiver and at least one second audio receiver, the first audio receiver receives the first audio signal, and the at least one second audio receiver receives the at least one second audio signal,
wherein the major voice signal is generated by a sound source, and the first audio receiver is used for receiving a maximum intensity of the major voice signal generated by the sound source, and the at least one second audio receiver is used for detecting noises of the major voice signal.

13. The audio processing system according to claim 12, further comprising:
a display unit, configured to a first side of the audio processing system, and displaying a message corresponding to the major voice signal,
wherein the first audio receiver is configured to the first side of the audio processing system, and the at least one second audio receiver is configured to at least one second side of the audio processing system, wherein the at least one second side and the first side are different.

14. The audio processing system according to claim 12, further comprising:
a wearable electronic device, coupled to the processing unit,
wherein the first audio receiver is configured in the wearable electronic device, the processing unit connects with the wearable electronic device through a wireless communication connection, and receives the first audio signal received by the first audio receiver through the wireless communication connection.

15. The audio processing system according to claim 14, further comprising:
a first wireless communication unit, coupled to the processing unit, and pairing with a second wireless communication unit of the wearable electronic device to establish the wireless communication connection with the second wireless communication unit.

16. The audio processing system according to claim 15, wherein the first wireless communication unit comprises at least one of a WiFi module or a Bluetooth module.

17. The audio processing system according to claim 11, wherein the processing unit is used to subtract the at least one third component signal from the first component signal to generate the major voice information.

18. The audio processing system according to claim 11, wherein the processing unit is used to subtract the at least one fourth component signal from the second component signal to generate the non-major voice information.

19. The audio processing system according to claim 11, wherein the processing unit is used to compare the major voice signal with a database for a voice recognition, and is used to execute a corresponding operation according to the major voice signal.

20. The audio processing system according to claim 19, wherein the processing unit is used to determine whether a voice feature of the major voice signal is identical to one of a plurality of voice features stored in the database, and when the voice feature of the major voice signal is not identical to the voice features stored in the database, the processing unit stores the voice feature of the major voice signal into the database.
